(19) United States
(12) Patent Application Publication
(10) Pub. No.: US 2009/0177510 A1
(43) Pub. Date: Jul. 9, 2009

(54) System and method of generating a business plan

(76) Inventor: L. Trenton Marsh, Washington, DC (US)

Correspondence Address: BUCHANAN, INGERSOLL & ROONEY PC, POST OFFICE BOX 1404, ALEXANDRIA, VA, 22313-1404, US

(21) Appl. No.: 12/007,031

(22) Filed: Jan. 4, 2008

(51) Int. Cl. G06Q 10/00

(52) U.S. Cl. 705/7

(57) ABSTRACT

Exemplary systems and methods are disclosed for generating a business plan on a network. An exemplary system comprises a first interface that generates business data associated with a client, a second interface that generates review data based on a review of the business data, and a processor connected to the first and second interfaces, wherein the processor generates the business plan based on the business data and review data of the first and second interfaces, respectively.

### FIELD OF THE DISCLOSURE

This invention is directed to the automated generation of a business plan through network resources.

### BACKGROUND OF THE DISCLOSURE

A business plan is a formal statement of a set of business goals, the reasons why the business goals are believed obtainable, and the plan for reaching those goals. In essence, business plans are decisions making tools. The content and format of the business plan is determined by the goal and audience. Banks are concerned about defaults, so a business plan for a bank loan will build a convincing case for an organization's ability to repay the loan. Venture capitalists are primarily concerned about initial investment, feasibility, and exist valuation. Entrepreneurs and small business owners generally lack the time, resources, and knowledge to prepare a business plan that will receive favorable evaluation from either a bank or venture capitalists. The preparation of a business plan draws on a wide range of knowledge from many different business disciplines, these include, finance, human resource development, intellectual property management, supply chain management, operations management, and marketing, among others. It is not surprising that most entrepreneurs find this process time consuming and at times overwhelming.

### SUMMARY

Exemplary systems and methods are disclosed for generating a business plan for network. An exemplary system comprises a first interface for generating business data associated with a client, a second interface for generating review data based on a review of the business data, and a processor connected to the first and second interfaces, wherein the processor generates the business plan based on the business data and review data of the first and second interfaces, respectively.

Exemplary embodiments are directed to a computing device configured to perform a method of generating a business plan over a network. The method comprising receiving client data from a first client through a first interface, obtaining industry-related data from resources connected to the network, and receiving review data from a second client through a second interface. The method also comprises generating the business plan based on the client data, industry-related data, and review data.

In addition, exemplary embodiments are directed to a computer-readable medium that stores a program for executing a method of generating a business plan on a computer connected to a network of devices. The method comprises generating a first interface for receiving data from a first device, generating a second interface for receiving data from a second device, and processing the data acquired from the first and second interfaces to generate a business plan.

### DESCRIPTION OF THE DRAWINGS

In the following, exemplary embodiments of the invention will be described in greater detail in reference to the drawings, wherein:

FIG. 1 illustrates an overview of a system in accordance with an exemplary embodiment;

FIG. 2 is a flow diagram of a method of accessing a diagnostic interface in accordance with an exemplary embodiment;

FIG. 3 illustrates a diagnostic interface in accordance with an exemplary embodiment;

FIGS. 4A and 4B illustrate a flow diagram of a method of generating a business plan in accordance with an exemplary embodiment; and

FIG. 5 illustrates a review interface in accordance with an exemplary embodiment.

### DETAILED DESCRIPTION

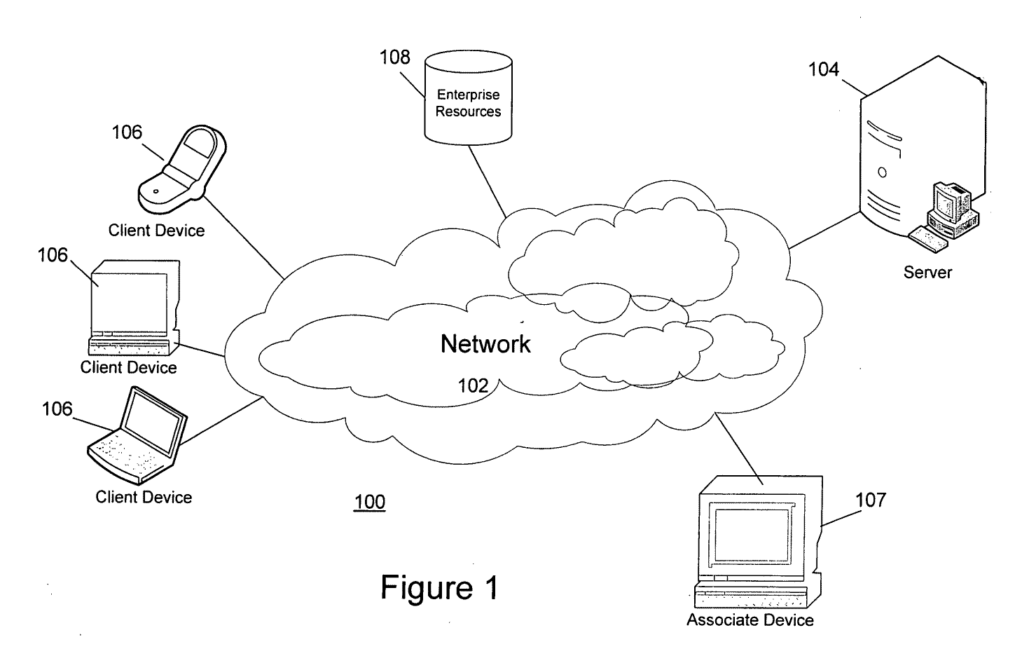

FIG. 1 is a block diagram of an exemplary system directed to generating a business plan over a network. The system 100 includes a network 102, a server 104, a plurality of client devices 106, a plurality of industry associate devices 107, and a plurality of enterprise resources 108. The client devices 106 and associate devices 107 can be any of various devices, such as personal computers, or internet tablets that can access various servers such as server 104. The client devices 106 and associate devices 107 are user devices that are connectable to the Internet and/or World Wide Web and that permit a user of the device to download information from the Internet. It will be understood by those skilled in the art that the client and associate devices 106, 107 include all manner of devices capable of downloading information from the World Wide Web and capable of uploading information to the World Wide Web, and is not in any way intended to limit the type of device that is connectable to the World Wide Web or Internet.

The network 102 enables multiple computers, processors, and/or computing devices to communicate over a shared bus. The shared bus can be implemented as a wired or wireless medium as desired. The network 102 can be implemented over any of a number of known protocols, including but not limited to an Internet protocol (IP) or World Wide Web. The network 102 can also be of various sizes such as a local area network (LAN), metropolitan network (MAN), wide area network (WAN), or any other scale as desired.

The server 104 can be configured to execute applications that are associated with generating a business plan. The server 104 can be a multi-user processor or computer that is configured as a server that provides numerous services or resources directed to generating the business plan over the network 102. The server 104 can be configured to include one or more processor units including routers, sequel servers (SQL), relational databases, processor units, and associated program memory. In operation, the server 104 responds to site users by providing menu screens and responding to actions from the users via an input device including, but not limited to, a keypad, keyboard, mouse, or other suitable device as desired. The operation of the web site portion of the server 104 with its various routers and sequel servers is substantially similar to the operation of known web site servers. The server 104 can be configured to receive requests from clients, process the requests and generate suitable responses. The server 104 can also be configured to include network security features such as user authentication or other known security techniques as desired. The user authentication can include a user ID/password combination for all users authorized to access the network 102 from one of the plurality of client devices 106. Firewall policies can be enforced to identify which services are allowed to be accessed by the network users. Moreover, data transmitted from the server 104 to other devices on the network 102 can be encrypted via any known encryption technique as desired.

The client devices 106 can be configured to communicate with the server 104 over a secured connection on the network 102 (i.e., over the Internet). The plurality of client devices 106 can be implemented through any computing device, processor, or any other suitable device as desired for connecting to and communicating over an IP network or the World Wide Web.

The plurality of enterprise resources 108 having sequel servers, and relational databases can be configured to include providers that retain data such as corporate facts and figures, and industry-related support information and other industry-related data, such as US Census information, SIC business ratios, forecasted Return on Investment, or other suitable data as desired. The data retained by the plurality of enterprise resources 108 can be in the form of books, portals, sources of written information, planning templates, published statistics, articles, abstracts, university resources, marketing reports, archives, and other means containing information for public dissemination as desired. The enterprise resources 108 can also include databases and any other storage location that may include data that is relevant to the industry of which the business plan is directed.

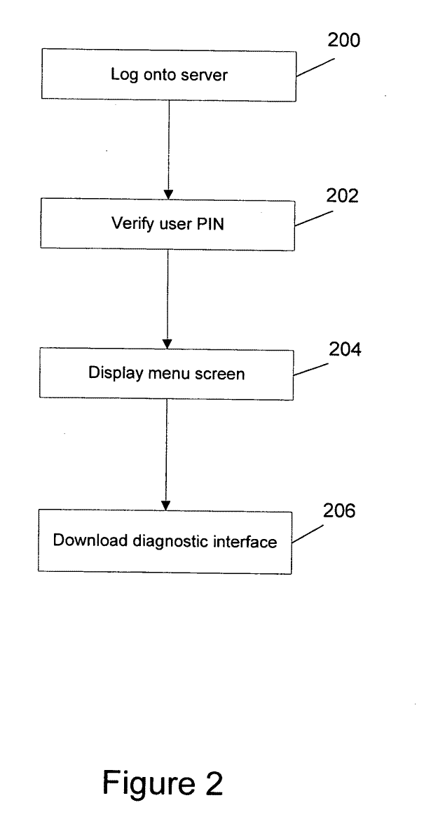

FIG. 2 is a flowchart of an exemplary method of accessing a diagnostic interface to a user over the network 102. The plurality of client devices 106, which can be allocated to a business client, can be used to access the website of the server 104 over the network 102 (step 200). The client device downloads a screen from the server 104 that permits the user to register with the system for the first time, in which instance the user can provide various registration information. The registration process utilized can be similar to any of known registration processes. If the user is already registered the user can provide a personal identification number (PIN) and the PIN can be verified by the server 104 (step 202). Once the PIN is verified, the server 104 authorizes the client device to download a menu screen (step 204). The user can select from any of a number of options, which can include but are not limited to downloading a diagnostic interface 110, sending a status request to the server 104, downloading a final business plan, and uploading the diagnostic interface 110.

The options displayed on the menu screen are enabled (i.e., selectable) based on an authorization level associated with the user PIN. For example, low to intermediate access levels can enable a menu selection that allows the user to obtain general information regarding business, request more information on the company providing the service of business plan generation, and/or request a meeting with a representative from the company providing the service. A high access level can enable a menu selection that allows the user to download the diagnostic interface.

If the user PIN has an associated high access level, at the menu screen, the user can select the diagnostic interface. The client device 106 communicates the user selection to the server 106, and the server 104 downloads the diagnostic interface 110 to the client device (step 206).

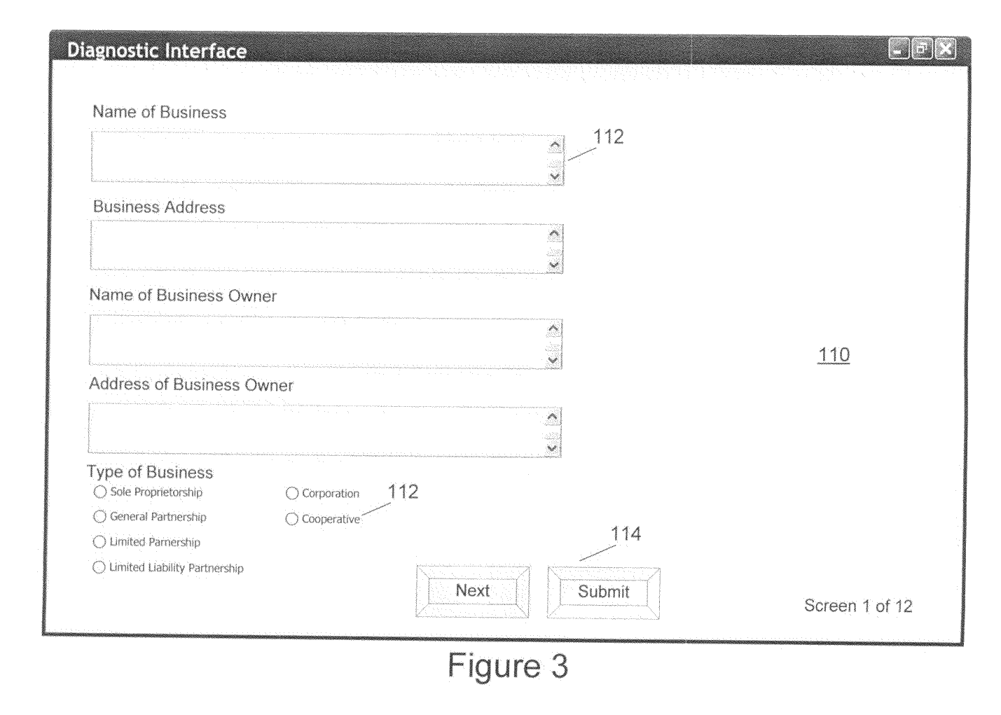

FIG. 3 illustrates an exemplary diagnostic interface 110. As shown in FIG. 3, the diagnostic interface 110 includes means, such as a plurality of graphical elements 112 (i.e., fields, radio button and/or other suitable features as desired). The graphical elements 112 can be associated with data related to the user's business, such as current revenue, owners of the business, revenue needed, vision or mission statement, expectations, and any other data as desired. The diagnostic interface 110 also includes a graphical element 114, such as a submit button. When activated, the submit button 114 initiates a process in which the business client 106 transmits all information and data input into the diagnostic interface 110 to the server 104.

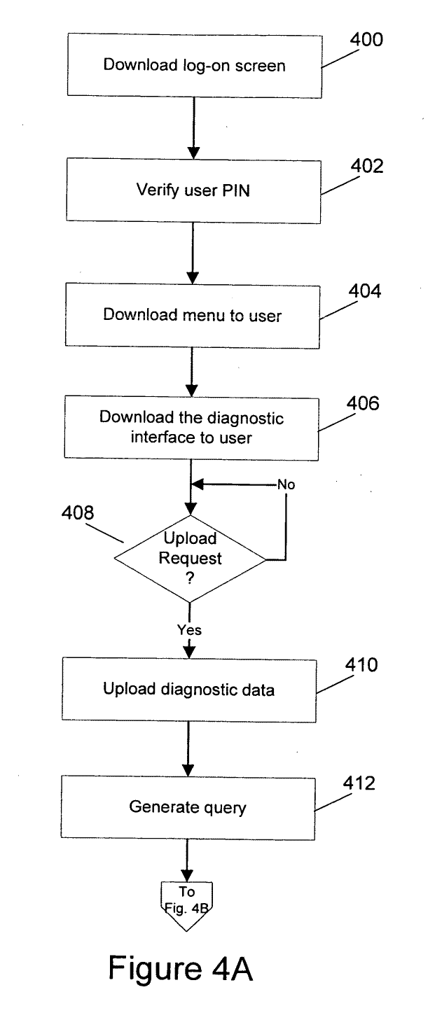

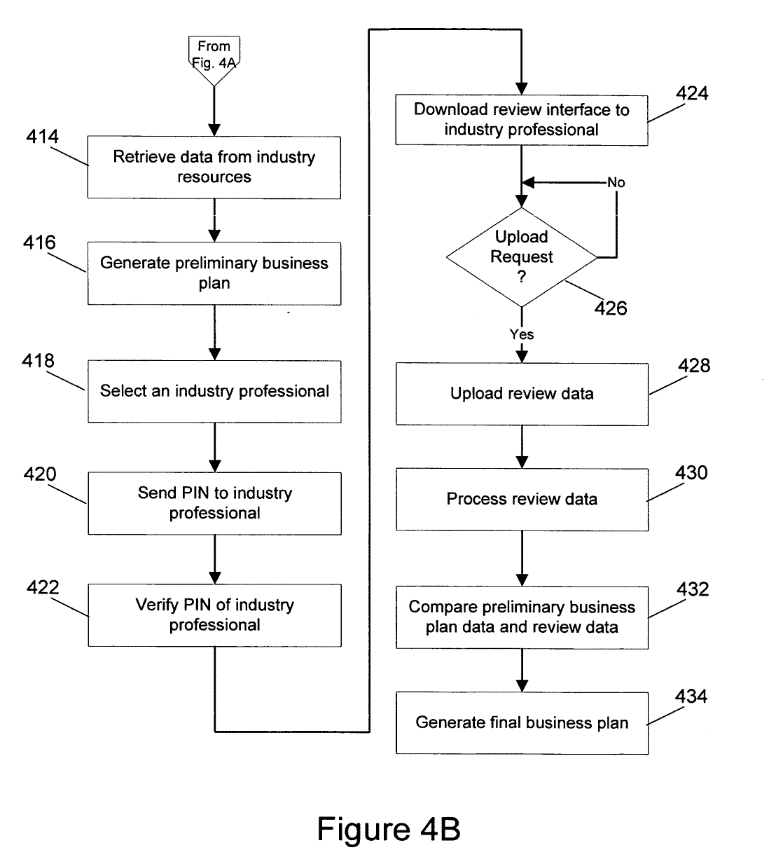

FIGS. 4A and 4B illustrate a flow diagram of a process of generating a business plan at the server 104. The server 104 responds to a communication from a client device 106 that includes log-on request by downloading a log-on screen to the client device 106 (step 400). The log-on screen requires that a user provide a PIN number. Upon receiving a communication from the client device 106 that includes the PIN number of the user, the server 104 verifies the validity of the PIN number by searching one or more of the databases for a match (step 402). If the PIN entry is determined to be a valid entry, the server 104 downloads a menu screen to the user (step 404). If the user selects to download the diagnostic interface 110, the appropriate application software the client device 106 communicates this request to the server 104 and the server 104 retrieves and downloads the diagnostic interface 406 to the client device 106 via an Internet connection (step 406). The server 104 monitors the connection to the client device 106 for a request to upload the diagnostic data (step 408). When a request is detected, the server 104 acknowledges the request and initiates an upload of the diagnostic data from the client device 106 (step 410).

The diagnostic data is processed at the managing server 104 in accordance with an algorithm to generate a query (step 412). The server 104 retrieves data from enterprise resources, such as related databases based on the query (step 414). The server 104 processes the data retrieved through the query and the uploaded diagnostic data based on an appropriate algorithm to generate a preliminary business plan (step 416). It can be appreciated by those skilled in the art that the steps of generating a query and retrieving data from the enterprise resources 108 can be managed and modified, as desired, by a representative of the company providing the service.

The preliminary business plan can be generated based on the business data received from the client through the diagnostic interface 110 and the industry-related data received from the enterprise resources 108. For example, the preliminary business plan can be generated from a template that is populated with the data received from the user through the diagnostic interface 110 and data received from the plurality of enterprise resources 108 on the network 102. It can be appreciated by those skilled in the art that the preliminary business plan can also be drafted by a representative of the company providing the service based on a review of the data received from the user (i.e., client) through the diagnostic interface 110 and data received from the plurality of enterprise resources 108. The preliminary business plan can include various sections such as executive summary, organizational background, marketing plans, operational plan, financial plan, risk analysis, and any other sections or data as needed.

Once the preliminary business plan is generated, the server 104 can select one of a plurality of industry professionals to review the preliminary business plan (Step 418). The server 104 compares the industry related to the business plan to a list or table of industry professionals stored in memory (not shown). The industry professional can be a professional that is knowledgeable in the industry associated with the business plan. The list of industry professionals can also identify at least one associate device 107, which is connected to the network 102 and allocated to the industry professional. The associate device 107 can include computing means, such as a personal computer, portable computer, handheld computer, cell phone, or any other processing device capable of connecting to the network 102 and communicating with the server 104 as desired. The server 104 selects one of the plurality industry professionals based on the industry that matches the industry of the business plan, and an availability of a network node to which the associate device 107 allocated to the industry professional is connected.

In addition, the industry professional can be selected based on whether the industry professional is available or has the capacity to review a preliminary business plan at that time. It can be appreciated by those skilled in the art that the availability and capacity can be communicated and tracked between the industry professional and the server through any of a plurality of known scheduling and project management software applications. Prior to being authorized to review a preliminary business plan, the industry professional should execute a confidentiality agreement to protect the client for which the preliminary business plan is generated from the unauthorized dissemination of confidential or proprietary information related to their business venture.

Once the industry professional is identified and selected, the server 104 sends an electronic communication to the at least one associate device 107 allocated to the industry professional through an electronic address associated with the industry professional and/or associate device 107 (Step 420). The electronic communication can be in the form of electronic mail, text message, or other communication technique as desired. The electronic communication can include a PIN that authorizes the industry professional to access the server 104 for reviewing the preliminary business plan. The electronic communication can also include a hypertext link to the preliminary business plan in the review interface 116.

The industry professional at the associate device 107 accesses the review interface 116 using the information provided in the electronic communication sent from the server 104. Interface 116 can be opened in a web browser and includes a plurality of graphical elements, such as fields and/or radio buttons that are associated with each section of the preliminary business plan. To ensure that the client for whom the preliminary business plan was generated remains unknown to the industry professional conducting the review, the server 104 creates aliases for the name(s) of the business owner(s), the company name, and any other data that might reveal the true identity of the client. The aliases can be created at the time data is received at the server 104 from the diagnostic interface 110 or prior to the industry professional accessing the review interface 116. The creation of aliases provides a level of security for the client and also ensures that the review maintains a high level of veracity. Access to the review interface 116 is contingent on the industry professional executing (i.e., signing) the confidentiality agreement.

The industry professional logs onto the website of the server 104 (step 422). The server 104 verifies the PIN through the associate device 107 sending a communication to the server 104 that includes the PIN of the industry associate and downloads a menu screen to the associate device 107 (step 424). The industry professional can initiate the download of the review interface by making the appropriate menu selection so that the associate device 107 can communicate the request to the server 107 (step 426). The server 107 downloads the review interface to the associate device based on the user selection (428). The server 104 monitors the network connection to the associate device 107 for a request to upload the review data from the associate device 107 (Step 430). When a request is detected, the server 104 enables the associate device 107 to upload the review data (432).

The server 104 processes the uploaded data in accordance with an appropriate algorithm for generating the final business plan by comparing the review data to the preliminary business plan (Step 434). The server 104 modifies the preliminary business plan to generate the final business plan based on the comparison result. The comparison involves analyzing the review data to identify text, phrases, figures, and other data that are different from the preliminary business plan. The algorithm enables the server 104 to revise the preliminary business plan based on the review data. The final business plan is then transmitted to the client device 106 for review. It can be appreciated by those skilled in the art that a representative of the company providing the service can manage or modify the generation of the final business plan as desired. For example, if the representative can communicate with the client and/or the industry professional regarding comments submitted to the server 104 by the industry professional through the review interface 116.

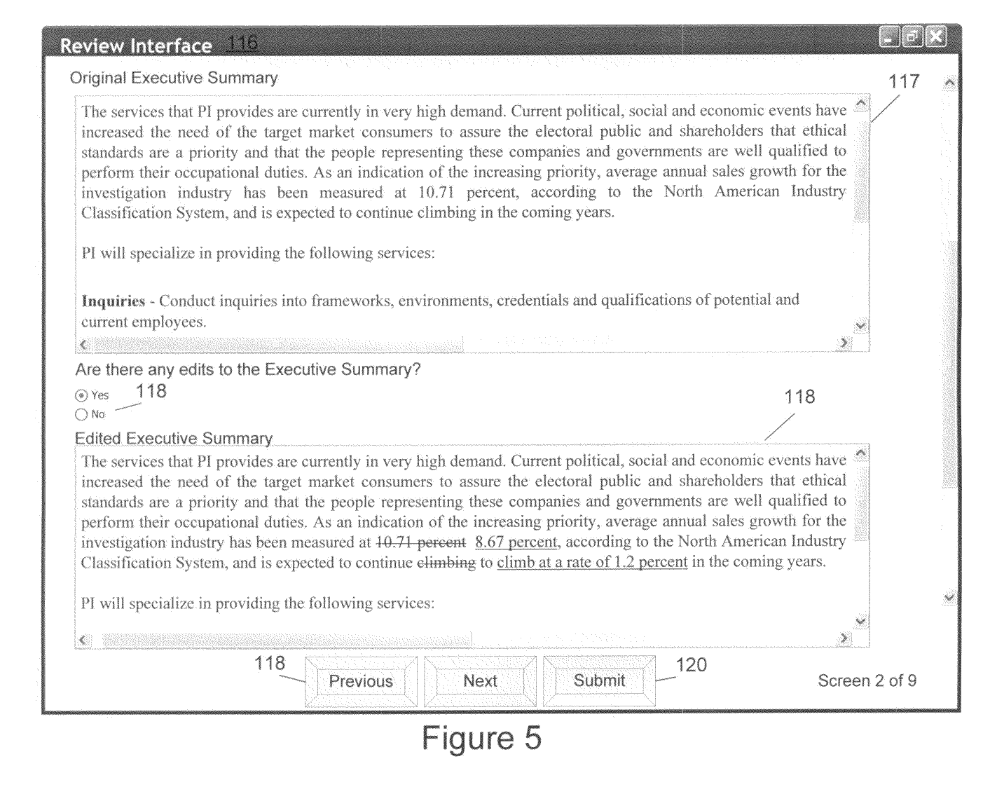

FIG. 5 illustrates an exemplary review interface 116 accessed by the industry professional at the associate device 107. As shown in FIG. 5, each section of the preliminary business plan can be associated with at least one of the plurality of graphical elements 116. For example, an executive summary section 117 can include means, such as a graphical element 118 (i.e., a field, radio button, or other digital feature as desired) so that the user can provide feedback on the content. The review interface 116 can include means, such as a graphical element 120, for submitting the contents of the review interface 116 to the server 104. Once the user at the client device 106 completes a review of the preliminary business plan, and the graphical element 120 is activated, the review interface 116 and all of its contents are transmitted to the server 104.

The systems and methods described herein connect a business owner or entrepreneur with a network of industry associates and enterprise resources so that a comprehensive business plan can be produced within a shortened time frame. The server 104 can manage the production of the business plan such each step in the process of generating the business plan is assigned a completion date. The business plan can be efficiently generated by limiting access to the server processes. In one embodiment, the server 104 can issue expiring IDs and/or passwords to the business clients and/or industry professionals for accessing the diagnostic interface 110 and the review interface 116, respectively. The diagnostic interface 110 and the review interface 116 can be configured so that they will not accept a user ID and password combination of a client (i.e., business owner or industry professional) after a predetermined amount of time has elapsed. The server 104 can be configured to track the amount of time remaining until the user ID and password combination expire and notify the client of the time remaining.

The systems and methods described herein can implement in software code that is stored on a computer readable medium. The computer readable medium can be used in configuring a computing device or processor, which is connected to a network of computing devices, to execute the aforementioned method for generating a business plan. One of ordinary skill in the art would appreciate that the computer readable medium can include an optical disk, floppy disk, flash memory, magnetic tape, or any other source medium as desired. The systems and methods can also be implemented in software code that is transferred between at least two computing devices on a network through magnetic signals, optical signals, electrical signals, or any other medium for transferring data between devices on a network as desired.

While the invention has been described with reference to specific embodiments, this description is merely representative of the invention and is not to be construed to limiting the invention. Various modifications and applications may occur to those skilled in the art without departing from the true spirit and scope of the invention as defined by the appending claims.

What I claim is:

1. A method for generating a business play over a network, the method comprising:
receiving client data from a first client through a first interface;
obtaining industry-related data from resources connected do the network;
receiving review data from a second client through a second interface; and
generating the business plan based on the client data, industry-related data, and review data.

2. The method of claim 1, comprising:
prompting a user at the first client to enter a user ID and password;
comparing the user ID/password combination input by the user to a plurality of stored user ID/password combinations; and
authorizing the user to access the first interface when the input combination matches one of the plurality of stored combinations.

3. The method of claim 1, wherein the authorizing step comprises:
allowing a user at the first client to access to the first interface for a limited time.

4. The method of claim 3, comprising:
determining a time remaining for access to the first interface; and
sending an electronic notification of the time remaining to the client.

5. The method of claim 1, comprising:
analyzing the received data to determine a relevant industry.

6. The method of claim 5, wherein the obtaining step comprises:
identifying databases and resources on the network that include data related to the relevant industry; and
accessing the identified databases to retrieve industry related data.

7. The method of claim 1, comprising:
generating a preliminary business report based on the client data and the industry-related data.

8. The method of claim 7, wherein the receiving step comprises:
authorizing a second user to access the second interface; and
displaying the second interface, wherein the second interface includes a plurality of graphical elements such as at least one of a preliminary business report, financial data, and business content.

9. A system for generating a business plan on a network, comprising:
a first interface for generating business data associated with a client;
a second interface for generating review data based on a review of the business data; and
a processor connected to the first and second interfaces, wherein the processor generates the business plan based on the business data and review data of the first and second interfaces, respectively.

10. A computer-readable medium that stores a program for executing a method of generating a business plan on a computer connected to a network of devices, the method comprising:
generating a first interface for receiving data from a first device;
generating a second interface for receiving data from a second device; and
processing the data acquired from the first and second interfaces to generate a business plan.

11. The computer-readable medium of claim 10, wherein the method comprises:
authorizing a first user to access the first interface; and
displaying the first interface on the first device.

12. The computer-readable medium of claim 10, wherein the method comprises:
analyzing the data received from the first device;
identifying industry-related resources on the network based on the analysis; and
extracting industry-related data from the identified resources.

13. The computer-readable medium of claim 10, wherein the method comprises:
authorizing a second user to access the second interface; and
displaying the second interface on the second device.

14. The computer-readable medium of claim 11, wherein the authorizing step comprises:
prompting the first user to input a user ID/password combination;
comparing the user ID/password combination input by the first user to a plurality of stored user ID/password combinations; and
authorizing the first user to access the first interface when the input combination matches one of the plurality of stored combinations.

15. The computer-readable medium of claim 13, wherein the authorizing step comprises:
prompting the second user to input a user ID/password combination;
comparing the user ID/password combination input by the second user to a plurality of stored user ID/password combinations; and
authorizing the second user to access the first interface when the input combination matches one of the plurality of stored combinations.
